(19) United States
(12) Patent Application Publication
(10) Pub. No.: US 2021/0308598 A1
(43) Pub. Date: Oct. 7, 2021

(54) METHOD FOR INSTALLING TRAYS IN PLATE TOWER

(71) Applicant: L'Air Liquide, Societe Anonyme pour l'Etude et l?Exploitation des Procedes Georges Claude, Paris (FR)

(72) Inventors: Qunfang LI, Zhejiang (CN); Philippe GRIGOLETTO, Paris (FR)

(73) Assignee: L'Air Liquide, Societe Anonyme pour l'Etude et l?Exploitation des Procedes Georges Claude, Paris (FR)

(21) Appl. No.: 17/265,126

(22) PCT Filed: Aug. 1, 2018
(86) PCT No.: PCT/CN2018/097981

§ 371 Date: Feb. 1, 2021

(51) Int. Cl. B01D 3/22; B01D 3/32

(52) U.S. Cl. CPC B01D 3/22; B01D 3/326

(57) ABSTRACT

A method for installing trays in a case where a plate tower is horizontally placed or approximately horizontally placed. No manhole is formed on a cylinder body of the plate tower, so as to reduce damage to the cylinder body of the plate tower, thereby improving the airtight performance of the plate tower. Since the trays are installed in a case where the plate tower is horizontally placed or approximately horizontally placed, manual operations are facilitated, manual working is reduced, and the potential safety hazard caused by high-place operations is avoided.

### CROSS REFERENCE TO RELATED APPLICATIONS

This application is a § 371 of International PCT Application PCT/CN2018/097981, filed Aug. 1, 2018, which is herein incorporated by reference in its entirety.

### TECHNICAL FIELD

The present invention relates to a method for installing plates in a plate column.

### BACKGROUND ART

A plate column is a type of gas-liquid mass transfer equipment that is used very widely. It is one of the most common types of process equipment in industries such as petrochemicals, natural gas processing and air separation. Its function is to bring a rising gas phase and a falling liquid phase into full contact with each other within the column, to achieve the objectives of heat transfer and mass transfer.

In general, a manhole is provided on a tubular body of the plate column, and the method of installing plates in the interior of the plate column is as follows: the plate column is positioned vertically, the plates are passed into the interior of the column body through the manhole on the tubular body, and installation is then carried out.

### SUMMARY OF THE INVENTION

In a conventional process, the method of installing the plates is carried out with the plate column positioned vertically, and requires that a manhole be provided on the tubular body, and that an operating platform be set up at the position of the manhole; in order to pass the plates through the manhole, it is necessary to split the plates into several plate sections, and then fix the plate sections to supporting rings of a plate column housing by means of clamping bolts. In the course of actual operation, the conventional installation method will give rise to the following problems: in a cryogenic separation process, the number of times that the manhole in the column body of the plate column is opened should be minimized, in order to improve the gas-tightness of the plate column; the installation of plate sections requires a large amount of manual work with the plate column positioned vertically, and carries a certain safety risk; and the setting up of a platform at the position of the manhole will consume a large amount of material resources, thereby increasing the cost of installation.

To solve the abovementioned technical problems, certain embodiments of the present invention provides a method for installing plates when a plate column is positioned horizontally or nearly horizontally, the method comprising the following steps: providing a plate column, with a tubular body being welded to a bottom header to form a column bottom of the plate column, and positioning the plate column horizontally or nearly horizontally, welding supporting rings in the interior of the tubular body at a set spacing; providing a plate having a walkway opened therein, ensuring that an outer edge of the plate overlaps at least partially with an inner edge of the supporting ring; entering the tubular body through an open column top of the plate column, and beginning to install the plate from the column bottom, fixing the plate at the side of the supporting ring that faces the column top; providing a walkway cover plate provided with a gas channel, ensuring that an outer edge of the walkway cover plate overlaps at least partially with an inner edge of the walkway, and fixing the walkway cover plate at the side of the plate that faces the column top; repeating the steps described above for installing the plate, installing the plates in sequence from the column bottom upwards, until the installation of the final plate at the column top is complete; finally, sealing the top of the tubular body.

Optionally, the plate is provided with a first through-hole located close to the edge of the plate that overlaps with the supporting ring; the plate is fixed at the side of the supporting ring that faces the column top by means of the first through-hole and a first fixing means, and may further optionally be fixed by a welding method.

Optionally, the plate is provided with a second through-hole located close to the edge of the walkway cover plate that overlaps with the plate; the walkway cover plate is fixed at the side of the plate that faces the column top by means of the second through-hole and a second fixing means, and may further optionally be fixed by a welding method. The welding method may be continuous welding or spot welding.

The first fixing means comprises a first bolt, a first nut and a first slide plate, and a fixing method comprises: positioning the first slide plate at the side of the supporting ring that faces the column bottom, wherein the first slide plate partially overlaps with the supporting ring; passing the first bolt through the first through-hole in the plate and the positioned first slide plate sequentially, in the direction from the column top to the column bottom; installing the first nut in the direction from the column bottom to the column top, and tightening.

The second fixing means comprises a second bolt, a second nut and a second slide plate, and a fixing method comprises: passing the second bolt through the second through-hole in the plate, in the direction from the column bottom to the column top; positioning the walkway cover plate, and positioning the second slide plate at the side of the walkway cover plate that faces the column top, wherein the second slide plate partially overlaps with the walkway cover plate; passing the second bolt, having already passed through the second through-hole in the plate, further through the second slide plate in the direction from the column bottom to the column top; installing the second nut in the direction from the column top to the column bottom, and tightening.

Optionally, a gas channel is provided on the walkway cover plate.

Optionally, the supporting ring and/or the plate is configured to be fan-shaped.

Optionally, the plate of the plate column comprises a bubble plate, floating-valve plate, sieve plate, tongue plate, mesh plate, vertical sieve plate, multiple-downcomer plate, Linde sieve plate, no-overflow plate or through-flow corrugated plate.

Optionally, the plate of the plate column may be split or folded into several small plate sections.

Certain embodiments of the present invention further provides a plate column suitable for the method described above, comprising a tubular body, a bottom header, a plate provided with a walkway, and a walkway cover plate, wherein no manhole is provided on the tubular body.

Certain embodiments of the present invention further provides a plate column suitable for the method described above; supporting rings are welded in the interior of a tubular body of the plate column at a set spacing, a plate has a walkway opened therein, a walkway cover plate is provided, and the structure of the plate thereof comprises: a gas channel; an overflow weir; a channel along which a liquid flows from an upper-layer plate to a lower-layer plate; and a downcomer; the plate is provided with a first through-hole enabling the installation of a first fixing means, the first through-hole being located close to an edge of the plate that overlaps with the supporting ring; and the plate is provided with a second through-hole enabling the installation of a second fixing means, the second through-hole being located close to an edge of the walkway cover plate that overlaps with the plate.

When the plate installation method disclosed in the present invention is employed, there is no need for a manhole to be opened on the tubular body, so the number of times that the column body of the plate column is opened is reduced, damage to the tubular body of the plate column is reduced, and the gas-tightness of the plate column is improved. Since the plates are installed when the plate column is positioned horizontally, manual work operations are facilitated, manual work is reduced, and the safety risk associated with working at height is avoided. There is no need to set up an installation platform at a manhole, so corresponding labour costs and the amount of on-site work are greatly reduced. The present invention employs a unique method of fixing, thus ensuring the safety of the plate column during transportation.

### BRIEF DESCRIPTION OF THE DRAWINGS

The drawings of the present disclosure merely illustrate the present invention, for understanding and interpreting the spirit of the present invention, but do not limit the present invention in any respect.

FIG. 1: a schematic drawing of the plate column when positioned horizontally

FIG. 2: a schematic drawing of the plate (without the walkway cover plate)

FIG. 3: a schematic drawing of the plate (with the walkway cover plate)

FIG. 4: a schematic drawing of the structures of the first and second fixing means

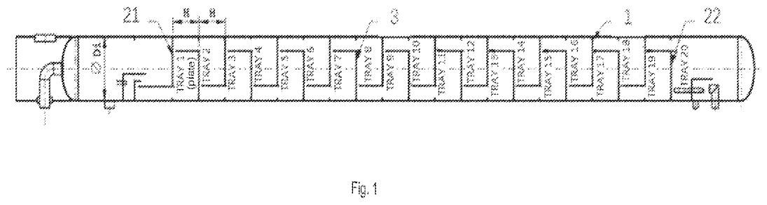

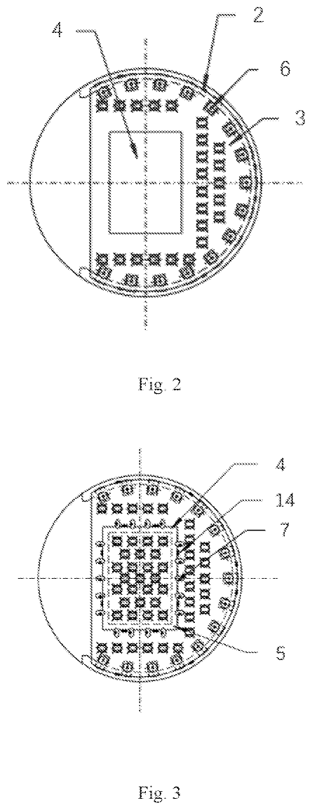

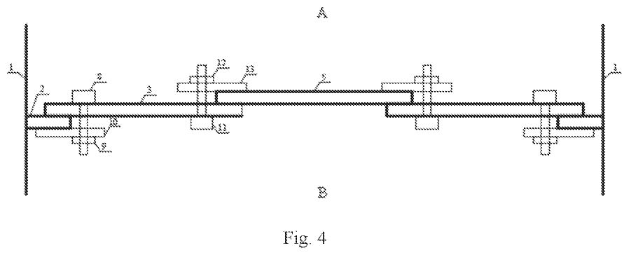

### DETAILED DESCRIPTION OF THE INVENTION

In the drawings: 1—tubular body; 2—supporting ring; 3—plate; 4—walkway; 5 —walkway cover plate; 6—first fixing means; 7—second fixing means; 8—first bolt; 9—first nut; 10—first slide plate; 11—second bolt; 12—second nut; 13—second slide plate; 14—spot weld; 21—column bottom plate; 22—column top plate; A—column top side; B—column bottom side.

The drawings are generally schematic, and are not drawn to scale for the sake of clarity.

All the drawings share the same reference labels for the same or corresponding technical features.

### Preferred Embodiments of the Invention

An overflow weir is used to ensure that a certain amount of liquid is stored on a plate, such that the gas and liquid phases have a sufficient contact surface.

In the course of rectification, liquid is stored on the horizontal plates, and gas flows from the column bottom towards the column top; gas channels on the plates are used to ensure that the gas and liquid phases can come into full contact with each other on the plates.

The present invention is described in greater detail below, partly in conjunction with the drawings.

As shown in the drawings: a plate column is provided; a tubular body 1 is welded to a bottom header, to form a column bottom of the plate column, and the plate column is positioned horizontally or nearly horizontally; supporting rings 2 are welded in the interior of the tubular body 1 at a set spacing. A plate 3 having a walkway 4 opened therein is provided, ensuring that an outer edge of the plate 3 overlaps at least partially with an inner edge of the supporting ring 2. The tubular body 1 is entered through an open column top of the plate column, and installation of the plate 3 is begun from the column bottom, fixing the plate 3 at the side of the supporting ring 2 that faces the column top. A walkway cover plate 5 provided with a gas channel is provided, ensuring that an outer edge of the walkway cover plate 5 overlaps at least partially with an inner edge of the walkway 4, and the walkway cover plate 5 is fixed at the side of the plate 3 that faces the column top. The steps described above for installing the plate 3 are repeated, installing the plates 3 in sequence from the column bottom upwards, until the installation of the final plate 3 at the column top is complete. Finally, the top of the tubular body 1 is sealed.

As shown in FIG. 4, optionally, the plate 3 is provided with a first through-hole located close to the edge of the plate 3 that overlaps with the supporting ring 2; the plate 3 is fixed at the side of the supporting ring 2 that faces the column top by means of the first through-hole and a first fixing means 6, and may further optionally be fixed by a welding method. Optionally, the plate 3 is provided with a second through-hole located close to the edge of the walkway cover plate 5 that overlaps with the plate 3; the walkway cover plate 5 is fixed at the side of the plate 3 that faces the column top by means of the second through-hole and a second fixing means 7, and may further optionally be fixed by a welding method.

The welding method may be continuous welding or spot welding.

The first fixing means 6 comprises a first bolt 8, a first nut 9 and a first slide plate 10, and the fixing method comprises: an operator enters through the open column top, and first of all positions the first slide plate 10 at the side of the supporting ring that faces the column bottom, wherein the first slide plate 10 partially overlaps with the supporting ring 3; the first bolt 8 is passed through the first through-hole in the plate and the first slide plate 10 sequentially, in the direction from the column top to the column bottom; the first nut 9 is installed in the direction from the column bottom to the column top, and tightened. The plate is then connected via the first fixing means to the supporting ring at other corresponding positions, in the same steps.

The second fixing means 7 comprises a second bolt 11, a second nut 12 and a second slide plate 13, and the fixing method comprises: the operator is located at the side of the plate that faces the column bottom, and passes the second bolt 11 through the second through-hole in the plate, in the direction from the column bottom to the column top; the operator goes through the walkway 4, moving from a column bottom side B to a column top side A; the walkway cover plate 5 is positioned, and the second slide plate 13 is positioned at the side of the walkway cover plate 5 that faces the column top, wherein the second slide plate 13 partially overlaps with the walkway cover plate 5; the second bolt 11, having already passed through the second through-hole in the plate, is further passed through the second slide plate 13 in the direction from the column bottom to the column top; the second nut 12 is installed in the direction from the column top to the column bottom, and tightened.

Rivets, hinges, snap-fittings and other fixing means may also be used to fulfil the function of fixing the plates and/or walkway cover plates as described above.

Optionally, a gas channel is provided on the walkway cover plate 5.

Optionally, the supporting ring 2 and/or the plate 3 is configured to be fan-shaped.

Optionally, the plate 3 of the plate column comprises a bubble plate, floating-valve plate, sieve plate, tongue plate, mesh plate, vertical sieve plate, multiple-downcomer plate, Linde sieve plate, no-overflow plate or through-flow corrugated plate.

Optionally, the plate 3 of the plate column may be split or folded into several small plate sections.

The present invention further provides a plate column suitable for the method described above, comprising a tubular body 1, a bottom header, a plate 3 provided with a walkway 4, and a walkway cover plate 5, wherein no manhole is provided on the tubular body 1.

The present invention further provides a plate column suitable for the method described above; supporting rings 3 are welded in the interior of a tubular body 1 of the plate column at a set spacing, plates have walkways 4 opened therein, walkway cover plates 5 are provided, and the structure of the plates 3 thereof comprises: a gas channel ensuring that gas and liquid phases can come into full contact with each other on the plate 3; an overflow weir ensuring that a certain amount of liquid is stored on the plate 3, such that the gas and liquid phases have a sufficient contact surface; a channel along which the liquid flows from an upper-layer plate to a lower-layer plate; and a downcomer, wherein the downcomer may be designed to be arched or round; the plate 3 is provided with a first through-hole enabling the installation of a first fixing means 6, the first through-hole being located close to an edge of the plate 3 that overlaps with the supporting ring 2; and the plate is provided with a second through-hole enabling the installation of a second fixing means 7, the second through-hole being located close to an edge of the walkway cover plate 5 that overlaps with the plate 3.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. A method for installing plates when a plate column is positioned horizontally or nearly horizontally, the method comprising:
a. providing a plate column, a column bottom thereof being formed by a bottom header and a tubular body welded together, and positioning the plate column horizontally or nearly horizontally, welding supporting rings in the interior of the tubular body at a set spacing;
b. providing a plate having a walkway opened therein, an outer edge of the plate overlapping at least partially with an inner edge of the supporting ring;
c. entering the tubular body through an open column top of the plate column, and beginning to install the plate from the column bottom, fixing the plate at the side of the supporting ring that faces the column top;
d. providing a walkway cover plate, an outer edge of the walkway cover plate overlapping at least partially with an inner edge of the walkway, and fixing the walkway cover plate at the side of the plate that faces the column top;
e. repeating steps b-d, installing the plate that is immediately adjacent at the side from the column bottom towards the column top, until the installation of the final plate at the column top is complete; and
f. sealing the top of the tubular body.

16. The method of claim 15, wherein the plate is provided with a first through-hole located close to the edge of the plate that overlaps with the supporting ring; in step c, the plate is fixed to the supporting ring by means of the first through-hole and a first fixing means.

17. The method of claim 15, wherein the plate is provided with a second through-hole located close to the edge of the walkway cover plate that overlaps with the plate; in step d, the walkway cover plate is fixed to the walkway by means of the second through-hole and a second fixing means.

18. The method of claim 16, wherein the plate and the supporting ring are welded together by a welding method.

19. The method of claim 17, wherein the walkway cover plate and the walkway are welded together by a welding method.

20. The method of claim 18, wherein the welding method comprises continuous welding or spot welding.

21. The method of claim 16, wherein the first fixing means comprises a first bolt, a first slide plate and a first nut, and a fixing method thereof comprises:
a. positioning the first slide plate at the side of the supporting ring that faces the column bottom, wherein the first slide plate partially overlaps with the supporting ring;
b. passing the first bolt through the first through-hole in the plate and the positioned first slide plate sequentially, in the direction from the column top to the column bottom;
c. installing the first nut in the direction from the column bottom to the column top, and tightening.

22. The method of claim 17, wherein the second fixing means comprises a second bolt, a second slide plate and a second nut, and a fixing method thereof comprises:
a. passing the second bolt through the second through-hole in the plate, in the direction from the column bottom to the column top;
b. positioning the walkway cover plate, and positioning the second slide plate at the side of the walkway cover plate that faces the column top, wherein the second slide plate partially overlaps with the walkway cover plate;
c. passing the second bolt, having already passed through the second through-hole in the plate, further through the second slide plate in the direction from the column bottom to the column top;
d. installing the second nut in the direction from the column top to the column bottom, and tightening.

23. The method of claim 15, wherein the walkway cover plate is provided with a gas channel.

24. The method of claim 15, wherein the supporting ring and/or the plate is fan-shaped.

25. The method of claim 15, wherein the plate of the plate column comprises a bubble plate, floating-valve plate, sieve plate, tongue plate, mesh plate, vertical sieve plate, multiple-downcomer plate, Linde sieve plate, no-overflow plate or through-flow corrugated plate.

26. The method of claim 15, wherein the plate of the plate column may be split or folded into several small plate sections.

27. A plate column suitable for the method of claim 15, comprising a tubular body, a bottom header, a plate provided with a walkway, and a walkway cover plate, characterized in that no manhole is provided on the tubular body of the plate column.

28. A plate column suitable for the method of claim 17, characterized in that supporting rings are welded in the interior of a tubular body of the plate column at a set spacing, a plate has a walkway opened therein, a walkway cover plate is provided, and the structure of the plate of the plate column further comprises: a gas channel; an overflow weir; a channel along which a liquid flows from an upper-layer plate to a lower-layer plate; and a downcomer; the plate is provided with a first through-hole enabling the installation of a first fixing means, the first through-hole being located close to an edge of the plate that overlaps with the supporting ring; and the plate is provided with a second through-hole enabling the installation of a second fixing means, the second through-hole being located close to an edge of the walkway cover plate that overlaps with the plate.
